(19) United States
(12) Patent Application Publication
(10) Pub. No.: US 2004/0169365 A1
(43) Pub. Date: Sep. 2, 2004

(54) Article in the forms of a book with a frame

(76) Inventors: Gabriella Piomboni, New York, NY (US); Stefano Campolmi, Milano (IT)

Correspondence Address: MORGAN & FINNEGAN, L.L.P., 345 PARK AVENUE, NEW YORK, NY, 10154, US

(21) Appl. No.: 10/450,132

(22) PCT Filed: Oct. 8, 2002
(86) PCT No.: PCT/IT02/00638

(51) Int. Cl. B42D 1/00

(52) U.S. Cl. 281/38

(57) ABSTRACT

The present invention relates to an article (1) in the form of a book comprising a plurality of pages ordered and bound together; the first page acts as the cover of the book and comprises a frame (2) which defines a window (21); on a following page (4) of the book is represented or applied or specifically applicable, in a position aligned with the window (21) of the frame (2), a subject (5) preferably artistic, flat or in relief; the subject (5) is visible through the window (21) of the frame (2) when the book is closed; this way the article (1) integrates both the function of a book and the function of a framed artistic subject.

### DESCRIPTION

The present invention relates to an article in the form of a book comprising of a plurality of pages ordered and bound to each other.

Framed pictures and books have always been well distinct and separate articles: framed pictures are monolithic objects, to be hung on a wall, to be used from a certain distance and in which the visual aspect prevails; books are articles that are divided into different components, to be handled, to be used in a near distance and in which the intellectual aspect prevails.

The considerations made in relation to framed pictures are valid also for other articles provided with a frame similar to that of pictures.

It is the object of the present invention to combine said articles, in particular a book and a framed picture.

Said combination has its own motivation typically if, for example, the subject of the picture and the subject of the book are the same or if they are related to each other: for example, an image of an artist and the life of that artist or a painting by an artist and the life of that artist and/or the description of that painting.

In order to achieve this object, two considerations have been made: the consideration that both the framed picture and the book are objects substantially flat and the additional consideration that both the component parts of a framed picture (the frame, the passe-par-tout, the painting) and both the components of a book (the cover, the pages) are objects substantially flat.

Based on these considerations, we then can perceive that the two articles can be not only combined, but also really integrated modifying slightly both articles.

The combination and integration are achieved in the articles in the form of a book having the features outlined in the independent claim 1 or in the independent claim 6.

The articles according to the present invention maintain the structure of a book (a plurality of pages ordered and bound together) but the first pages simulate the structure of a framed picture (frame, passe-par-tout, artistic subject) totally or partially combined.

Advantageous aspects of the articles according to the present invention are outlined in the dependent claims.

Some examples of embodiments of the present invention will be outlined hereafter with the aid of the attached drawings, in which:

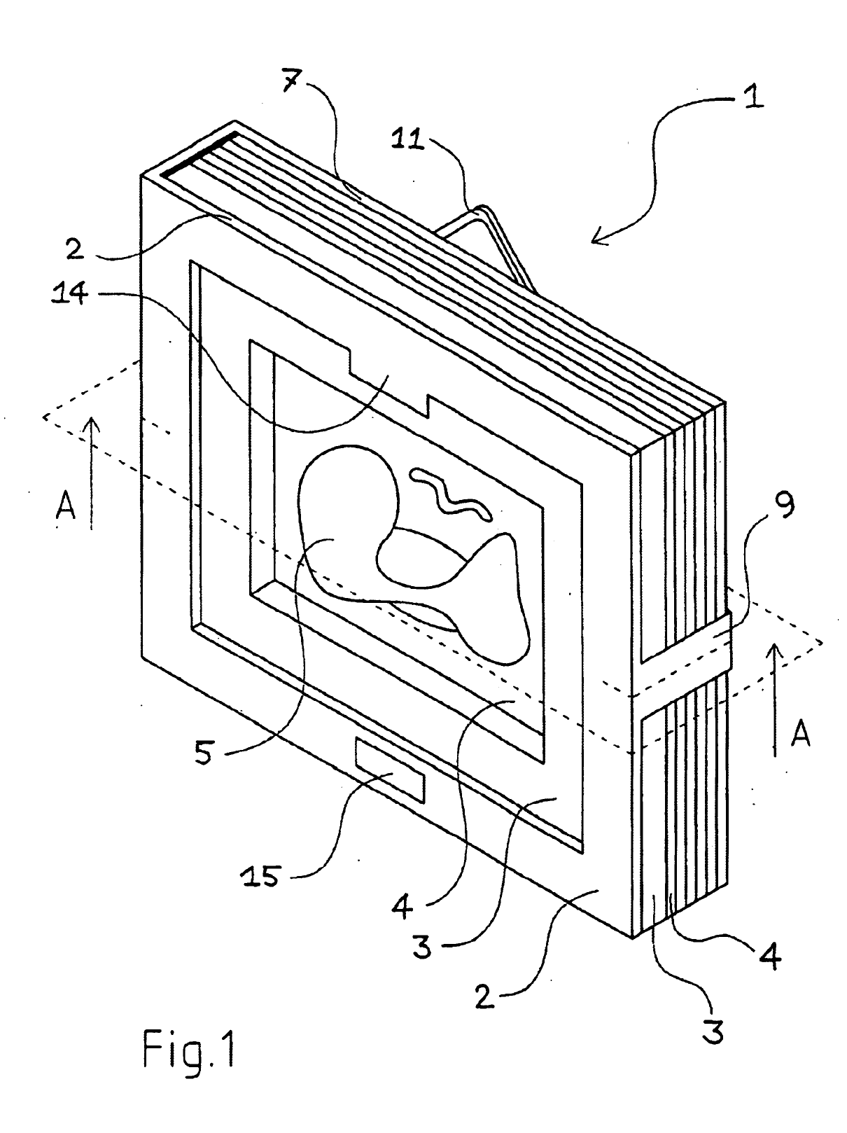

FIG. 1 shows a schematic prospective view of an article according to the present invention,

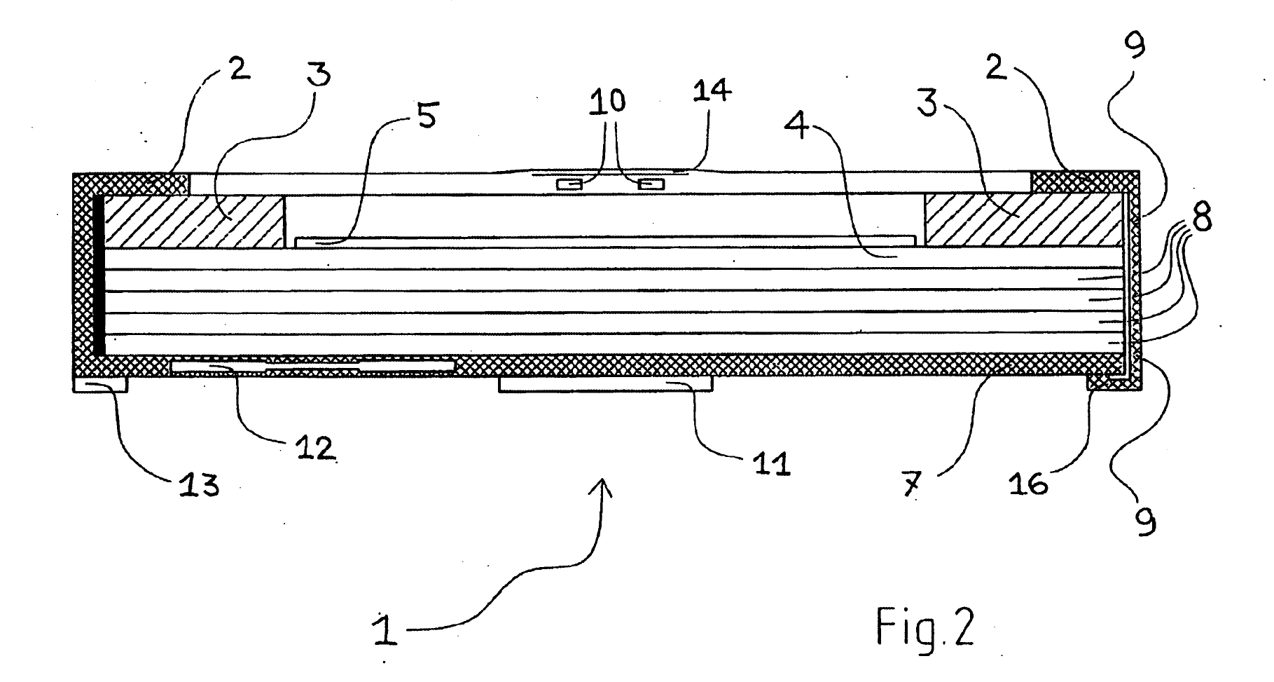

FIG. 2 shows a schematic view according to the plane A-A of the article of FIG. 1,

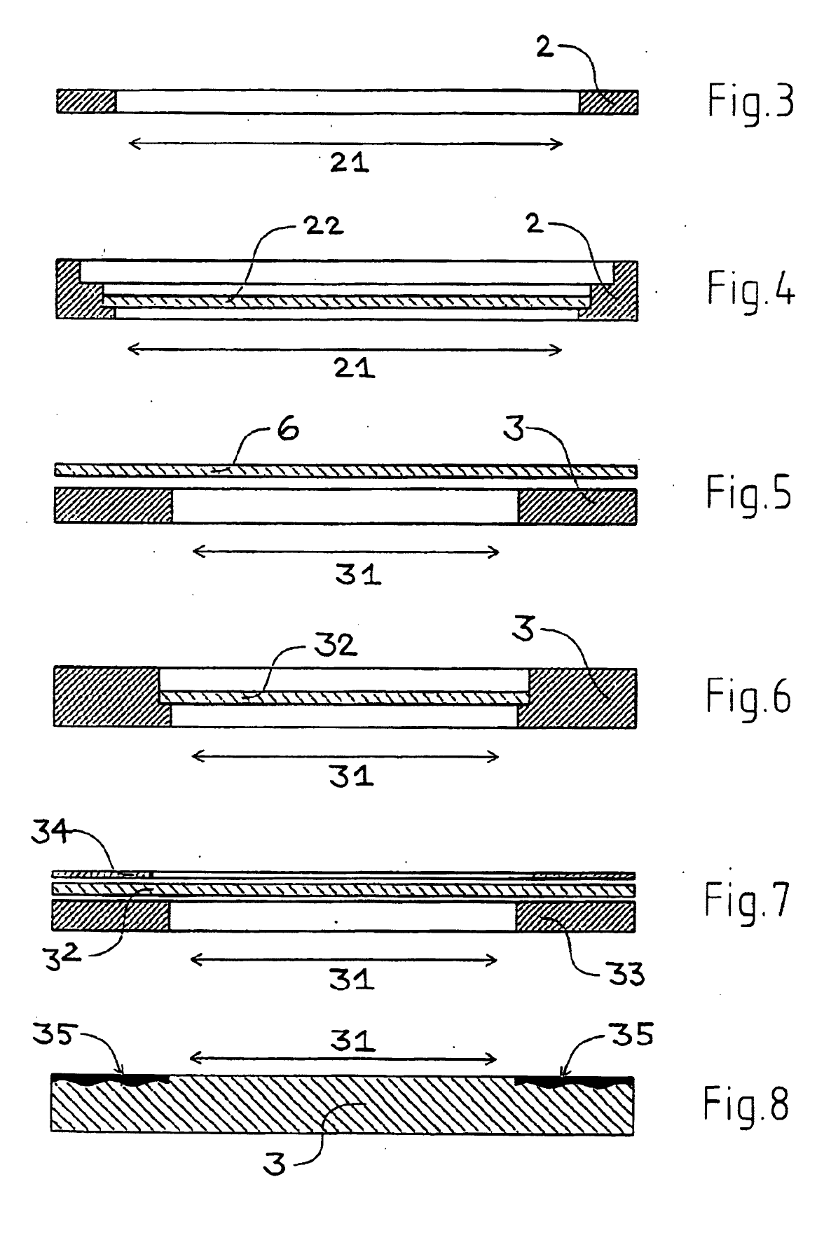

FIG. 3 show a cross-section view of an example of a frame page for an article according to the present invention,

FIG. 4 shows a cross-section view of another example of a frame page for an article according to the present invention,

FIG. 5 shows a cross-section view of a first example of a passe-par-tout page for an article according to the present invention,

FIG. 6 shows a cross-section view of a second example of a passe-par-tout page for an article according to the present invention,

FIG. 7 shows a cross-section view of a third example of a passe-par-tout page for an article according to the present invention,

FIG. 8 shows a cross-section view of a fourth example of a passe-par-tout page for an article according to the present invention.

The article according to the present invention has substantially the shape of a book and comprises a plurality of pages ordered and bound together; the present invention is independent of the type of binding used; among the binding types normally used in the book (publishing) area we can mention: saddle stitches, sewn signatures, spiral binding, paperback binding; the examples shown in FIG. 1 and FIG. 2 have both a paperback binding.

In the article according to the present invention, the first page acts as the cover of the book; the first page comprises or it is constituted essentially by a frame; the frame defines its own window; on a following page of the book it is represented or applied or specifically applicable, in a position aligned with the window of the frame, a subject preferably artistic, flat or in relief; the subject is visible through the window of the frame when the book is closed.

The article according to the present invention integrates the functions of two different articles: an article with a frame (typically a framed picture) and an article with bound pages (typically a book); many can be the articles with a frame; many can be also the articles with bound pages, for example: books strictly for reading, illustrated books, activity books, coloring books, etc.

As it will be better clarified further below, according to the present invention, many are the subjects adapted to be shown through the frame, either of substantially bi-dimensional or three-dimensional type, and either of strict artistic type or broader artistic type. Depending on the type of the subject, this can be more advantageously represented (for example printed or drawn) or applied (for example glued) or specifically applicable (for example by inserting it in a pocket of transparent material or by being imbedded in a niche). The position of the subject must take into consideration the position of the window of the frame both to make sure that the subject is visible through the window of the frame when the book is closed and to give a pleasant esthetic aspect (in some cases, for example it will be advisable to center the subject in relation to the window of the frame); there is not in any way the need to match the perimeter of the window with the perimeter of the subject.

The present invention is independent, in general, from the shape of the book, of the frame, of the window and of the subject; among the various shapes we can mention for example: square, rectangle, triangle, circle, and ellipse.

The frames that can be used for the article according to the present invention can be very different: a certain frame can resemble a traditional picture frame but can also resemble, for example, the frame of a television screen or the frame of a home window; a frame that can be used in the present invention can also be a multiple type, that is to say subdivided in more squares each surrounding a different subject or a different section of the same subject.

As far as the dimensions are concerned, typical applications of the present invention can have a vertical dimension (correspondent to the bulk of the book) from 1 cm up to 2 cm and a horizontal dimension from about 5 cm to 20 cm; however higher dimensions are not to be excluded.

The present invention is also, in general, independent of the material used for the various pages of the book and for the subject; among the various materials we can mention, for example: paper, board, wood, fabric, glass, metal, plastic; a plastic material that could be used, in particular for articles according to the present invention addressed to children, is EVA (Ethylene Vinyl Acetate).

The present invention can include advantageously, but not necessarily, a passe-par-tout behind the frame; the passe-par-tout defines its own window aligned with the window of the frame and such so that the subject is visible also through the window of the passe-par-tout when the book is closed; the passe-par-tout can be used to give a feeling of depth. The position of the window of the passe-par-tout must take into consideration the position of the window of the frame either to make sure that the subject is visible through the window of the passe-par-tout when the book is closed and to give a pleasant esthetic aspect (in some cases for example, it will be advisable to center the subject in relation to the passe-par-tout); there is not in any way the need to match the perimeter of the window of the passe-par-tout with the perimeter of the window of the frame: for example, in the framed pictures, the passe-par-tout is often well visible behind the frame.

The considerations made above are also valid for the shape and for the material of the passe-par-tout.

A good perception of depth is obtained when the passe-par-tout has a thickness comprised between 1 mm and 1 cm approximately; a higher thickness would certainly give a better perception of depth, but would create binding problems.

The present invention can include advantageously but not necessarily a transparent material in the form of a plate or pane in correspondence of the entire window of the frame and/or of the passe-par-tout; the transparent material can serve as protection of the subject or to improve the esthetic aspect of the article. Typically the transparent material used will be a kind of plastic both for reasons of weight and fragility, as well as for reasons of transparency; it is not excluded, however, that in some cases another type of material could be used, glass for example.

The transparent material can constitute an entire book page; or the transparent material can be applied (for example glued or embedded) to the frame or to the passe-par-tout; or in addition, the pane of transparent material can be integrated in the frame or in the passe-par-tout.

According to the present invention, any or all the parts of the article, the frame, the passe-par-tout, the pane of transparent material, the page associated with the subject can be present in the article and can be bound together in many different ways so as to form one or more pages of the article, for example not considering the pane of transparent material: (A) anyone of these elements can constitute one single page, (B) the frame and the passe-par-tout can be bound together so as to form one single page, (C) the passe-par-tout and the page associated with the subject can be bound together so as to form one single page, (D) the frame, the passe-par-tout and the page associated with the subject can be bound together so as to form one single page.

The example on FIG. 1 and FIG. 2 corresponds to the case in which the first page is constituted essentially by the sole frame.

In these figures, an article 1 in the form of a book according to the present invention comprises a plurality of distinct pages, ordered and bound together in a paperback form; the first page acts as the cover of the book and it is essentially constituted by a frame 2 which defines its own window 21; the second page is essentially constituted by a passe-par-tout 3 which defines its own window 31; the third page is constituted by a page 4 made of board with an artistic and substantially flat subject applied over (in a very schematic way, a painting); these three pages are followed (in this case) by four board and printed pages 8 which contain, among others, written text; at the end there is a page 7 which acts as back cover. The article 1 is shown in the figures in a closed position; in such a position, the subject 5 is visible both through the window 21 of the frame 2 and through the window 31 of the passe-par-tout 3.

In the article 1 of FIG. 1 and FIG. 2 according to the present invention is not included any pane of transparent material; this article however could be easily modified by inserting an entire page of transparent material, for example, between the first and second pages or gluing, for example, a pane of transparent material to the passe-par-tout 3.

The subject 5 of FIG. 1 and FIG. 2 is a painting.

As a first option, the subject can be a drawing or a print or a photographic image or something similar; part of this list are also, for example, the image of a comic strip or cartoon character and the image of a soccer player.

As a second option, the subject can be a photograph or something similar.

As a third option, the subject can be a stamp or a coin or something similar.

As a fourth option, the subject can be a lace or a piece of fabric or something similar.

As a fifth option, the subject can be a bas-relief or a high-relief or something similar.

Some of the subjects described above are artistic subjects in a strict sense, others are artistic subjects in a broader sense, other are not artistic at all.

The printed text on the pages 8 of the article 1 has a content related to the subject 5; this aspect is one of the key elements of the present invention.

Below are shown with the help of FIG. 1 and FIG. 2, other advantageous features of the present invention.

The article 1 can further include a device 11 to allow it to be hung on a wall. Such device is, in the illustrated embodiment, a ring, e.g., in triangular form, attached to the back page 7 via a small mounting plate. In this way, the function of a framed picture (or similar article) is more complete.

The article 1 can include a device 9 adapted, to, in a specific condition, to keep all the pages closed together; in particular it is a wrapper with a small tooth 16 to hook up with page 7 which is the back cover; such a closing device is useful in general, but it is particularly useful in combination with device 11: in fact, if the article 1 would be hung on a wall through device 11 without device 9, the article would tend to open up with the result that the frame 2 would not surround the subject 5 any longer.

For better placement of article 1 when hung on a wall, a thin strip 13 can be included as compensation for the depth of any device 9 or 11 and further more it is preferable, but not essential, that the strip 13, the tooth of the device 9 and the plate of the device 11 be of the same thickness.

With a choice of device 9 and device 11 different from that shown in FIG. 1 and FIG. 2, and having the same scope, it is possible to advantageously avoid any protuberance from page 7 of the back cover; in this case the ruler 13 becomes unnecessary.

The article 1 can comprise a device 10 adapted to light up the subject 5; it is in particular made of two micro light bulbs or two diodes of LED type (Light Emitting Diode) applied to the frame 2 on the top part of its window (when the article is hung) similar to framed pictures in museums; in correspondence of the two light bulbs it can be included, on the frame 2, a small screen 14 to avoid the dazzling effect and also to better direct the light towards the subject 5.

The lighting device can be made in many other ways and can be positioned in other parts of the article; it can be included in the frame 2 or in the passe-par-tout 3 or in neither one.

The article 1 shows a plate 15 on which in small letters it is reproduced the name of the author of the painting similarly to museums' framed pictures; naturally other additional information can be added to it.

The article 1 could also include a device adapted to reproduce sounds. Sounds can be music and/or voices and/or noise. The sound device can be, for example, an electronic system to record sounds, or a device to reproduce sounds and a device to emit sounds.

Both the lighting device and the sound device are electrical devices and they need electric power; in the case of an article according to the present invention, the only source of energy practically usable and with a limited cost are batteries; in the article 1 of FIG. 1 and FIG. 2 it is included a space 12 created on the page 7 of the back cover adapted to contain two batteries of the flat type. The batteries, or more in general, the devices for electric power production can also be positioned elsewhere.

Both the lighting device and sound device, when present in the article 1, need of a device which will turn on the light feature and the sound feature respectively; there are many practical options; the simplest option is constituted by a switch that can be operated manually; a more complex option is a switch that will turn on and off with the opening and closing of the book.

The article 1 could also have a device adapted to contain a CD or a DVD or a similar memory tool adapted to contain data and/or sound and/or images; such a device could be, for example, a pocket applied or created on the page 7 of the back cover. Also in this case there will advantageously be a correlation between the subject, the content of the text and the content of the CD or DVD.

As far as the types of materials, we have already said that there is ample choice; in a typical embodiment as the one of FIG. 1 and of FIG. 2, all the pages of the article 1 are made of board, but have different thickness; in particular the pages 8 are made of board and are all the same.

As we can understand from these figures, the article 1 not only can be hung on a wall, not only can be placed flat on its back cover, but it can also be placed standing up in perfect balance on the bottom side thanks to the thickness of its pages. The article according to the present invention does not exclude any other options of support already known in the field of the articles with bound pages or in the field of the articles in frames.

Some, or all the pages of the article according to the present invention can be adapted to be written; the material that can be used in this case is typically paper.

Below are illustrated, with the help of the figures, the structures of some samples of frames and passe-par-tout adapted to this invention.

FIG. 3 shows a simple frame 2 with its own window 21.

FIG. 4 shows a frame 2 with a border built in a step like manner; in one of the steps is inserted a pane 22 of transparent material.

FIG. 5 shows a simple passe-par-tout 3 with its own window 31; it is also shown a pane 6 of transparent material separate from the passe-par-tout 3; as an alternative, this could be also glued to the passe-par-tout 3 and therefore could become a single page of the article.

FIG. 6 shows a passe-par-tout 3 built in a step like manner; in one of the steps is inserted a pane 32 of transparent material.

FIG. 7 shows a passe-par-tout 3 formed by a lower plate 33 (provided with a window) with a pane 32 of transparent material applied over, an additional upper plate 34 (provided with a window) is applied over to secure pane 32 to plate 33.

FIG. 8 shows a passe-par-tout 3 made of a thick pane of transparent material; in correspondence of the perimeter area of the top surface of the passe-par-tout 3 ink 35 has been applied; the inked surface defines the window 31 of the passe-par-tout.

1. Article (1) in the form of a book comprising of a plurality of pages ordered and bound together, characterized in that the first page acts as the cover of the book and consists essentially of a frame (2) which defines its own window (21), in that on a following page (4) of the book it is represented or applied or specifically applicable, in a position aligned with the window (21) of the frame (2), a subject (5) preferably artistic, flat or in relief, and in that the subject (5) is visible through the window (21) of the frame (2) when the book is closed.

2. Article according to claim 1, wherein a page of the book bound between the first page (2) and the page (4) associated to said subject (5), is substantially constituted by a passe-par-tout (3) which defines its own window (31) aligned with the window (21) of the frame (2), and wherein the subject (5) is visible also through the window (31) of the passe-par-tout (3) when the book is closed.

3. Article according to claim 1, wherein the page (4) associated to said subject (5) comprises of a passe-par-tout which defines its own window aligned with the window (21) of the frame (2), and wherein the subject (5) is visible also through the window of the passe-par-tout when the book is closed.

4. Article according to anyone of claims from 1 to 3, wherein in correspondence of the entire window (21,31), the frame (2) and/or the passe-par-tout (3) includes transparent material (22,32) in the form of a pane.

5. Article according to anyone of claims from 1 to 3, comprising a page (6) made of transparent material at least in correspondence of the entire window (21,22) of the frame (2) and/or of the passe-par-tout (3) bound in the book after the frame (2) or after the passe-par-tout (3).

6. Article (1) in the form of a book comprising a plurality of pages ordered and bound together, characterized in that the first page acts as the cover of the book and comprises a frame (2) which defines its own window (21), and characterized in that on a following page (4) of the book is represented or applied or specifically applicable, in a position aligned with the window (21) of the frame (2), a subject (5) preferably artistic, flat or in relief, and characterized in that the subject (5) is visible through the window (21) of the frame (2) when the book is closed.

7. Article according to claim 6, wherein the first page further comprises of a passe-par-tout (3) which defines its own window (31) aligned with the window (21) of the frame (2), the passe-par-tout being placed under the frame (2), and wherein the subject (5) is visible also through the window (31) of the passe-par-tout (3) when the book is closed.

8. Article according to claim 7, wherein in correspondence of the entire window (21,31), the frame (2) and/or the passe-par-tout (3) includes transparent material (22,32) in the form of a pane.

9. Article according to claim 7, comprising a page (6) made of transparent material at least in correspondence of the entire window (21,31) of the frame (2) and/or of the passe-par-tout (3) bound in the book after the frame (2) and after the passe-par-tout (3).

10. Article according to one of the previous claims, wherein the passe-par-tout (3) has a thickness comprised between about 1 mm and about 1 cm so as to give a feeling of depth.

11. Article according to anyone of the previous claims, wherein said subject (5) is a painting, or a design, or a print or a photographic image.

12. Article according to anyone of the previous claims, wherein said subject (5) is a photograph.

13. Article according to anyone of the previous claims, wherein said subject (5) is a stamp or a coin.

14. Article according to anyone of the previous claims, wherein said subject (5) is a lace or a piece of fabric.

15. Article according to anyone of the previous claims, wherein said subject (5) is a bas-relief or high-relief.

16. Article according to anyone of the previous claims, wherein the content of the written pages (8) of the book is related to the subject (5).

17. Article according to anyone of the previous claims, provided with a device (9) adapted to, in a specific condition, to keep all the pages closed together.

18. Article according to anyone of the previous claims, provided with a device (10) adapted to light up said subject (5).

19. Article according to claim 18, wherein said lighting device (10) is contained in the frame (2) or in the passe-par-tout (3).

20. Article according anyone of the previous claims, provided with a device adapted to generate sounds.

21. Article according to anyone of the previous claims, provided with a device (11) adapted to hang the article on a wall.

22. Article according to anyone of the previous claims, wherein all or at least some of the pages are made of board.

23. Article according to anyone of the previous claims, wherein at least some of the pages are adapted to be written.

24. Article according to anyone of the previous claims, comprising of a device adapted to contain a CD or a DVD or similar means adapted to contain data and/or sounds and/or images.
